(19) United States
(12) Patent Application Publication
(10) Pub. No.: US 2024/0241319 A1
(43) Pub. Date: Jul. 18, 2024

(54) OPTICAL ELEMENT ARRAY, OPTICAL SYSTEM INCLUDING THE OPTICAL ELEMENT ARRAY, AND METHOD OF MANUFACTURING THE OPTICAL ELEMENT ARRAY

(71) Applicant: Samsung Electronics Co., LTD., Suwon-si (KR)

(72) Inventors: Dongsik SHIM, Suwon-si (KR); Eunkyung Lee, Suwon-si (KR); Bongyong Jang, Suwon-si (KR); Chnaggyun Shin, Suwon-si (KR)

(73) Assignee: Samsung Electronics Co., LTD., Suwon-si (KR)

(21) Appl. No.: 18/414,694

(22) Filed: Jan. 17, 2024

(30) Foreign Application Priority Data
Jan. 17, 2023 (KR) 10-2023-0006983
Mar. 30, 2023 (KR) 10-2023-0042252

(51) Int. Cl. G02B 6/293

(52) U.S. Cl. CPC G02B 6/29301; G02B 6/29395

(57) ABSTRACT

An optical element array and a method of manufacturing the optical element array are provided. The optical element array includes a substrate, an optical passive element layer provided on the substrate and including at least one waveguide, and at least one optical active element provided on the optical passive element layer. An input and output region of the at least one optical active element includes a tapered region.

### CROSS-REFERENCE TO RELATED APPLICATION

This application is based on and claims priority under 35 U.S.C. § 119 to Korean Patent Application No. 10-2023-0006983, filed on Jan. 17, 2023, and Korean Patent Application No. 10-2023-0042252, filed on Mar. 30, 2023, in the Korean Intellectual Property Office, the disclosures of which are incorporated by reference herein in their entireties.

### BACKGROUND

### 1. Field

The disclosure relates to an optical element array, an optical system including the optical element array, and a method of manufacturing the optical element array, and more particularly, to an optical element array with low light reflection, an optical system including the optical element array, and a method of manufacturing the optical element array.

### 2. Description of the Related Art

Recently, photonic integrated circuits (PICs), in which optical elements are integrated, have been used in various optical sensors or optical interconnection fields. Optical active elements used in PICs include, for example, a light source that converts electrical energy into light energy, a modulator that modulates light, an amplifier that amplifies light, a transceiver that transmits and receives light, and the like.

On the other hand, light loss caused by light reflection may occur when light output from an optical active element is received into a waveguide or when light inside a waveguide is input to an optical active element.

### SUMMARY

Provided are an optical element array with low light reflection, an optical system including the optical element array, and a method of manufacturing the optical element array.

Additional aspects will be set forth in part in the description which follows and, in part, will be apparent from the description, or may be learned by practice of the presented embodiments of the disclosure.

According to an aspect of an embodiment, an optical element array may include: a substrate; an optical passive element layer provided on the substrate and including at least one waveguide; and at least one optical active element provided on the optical passive element layer, wherein an input and output region of the at least one optical active element may include a tapered region inclined in an x-direction, a y-direction, and a z-direction, and wherein the z-direction is a height direction of the substrate, along with the optical passive element layer and the at least one optical active element are stacked, and the x-direction and the y-direction are perpendicular to the z-direction and to each other.

A width of the tapered region in the x-direction may be 5 μm to 20 μm, a length of the tapered region in the y-direction may be 5 μm to 30 μm, and a height of the tapered region in the z-direction may be 1 μm to 3 μm.

An angle between a surface of the tapered region inclined in the z-direction and one surface of the substrate may be 5 degrees to 50 degrees.

The tapered region includes a semiconductor material and a first mask material.

The semiconductor material may include a Group III-V semiconductor material.

The first mask material may include any one or any combination of SiN, silicon oxide, SiON, spin-on-glass (SOG), aluminum oxide, ArO, SiOF, and benzocyclobutene (BCB), borophosphosilicate glass (BPSG), and any combination thereof.

According to another aspect of an embodiment, an optical system may include: an optical element array configured to generate light and adjust a traveling direction of the light toward an object; a receiver configured to receive light from the object; and a processor configured to control the receiver and the optical element array, wherein the optical element array may include: a substrate; an optical passive element layer on the substrate and including at least one waveguide; and at least one optical active element on the optical passive element layer, wherein an input and output region of the at least one optical active element may include a tapered region inclined in an x-direction, a y-direction, and a z-direction, and wherein the z-direction may be a height direction of the substrate, along with the optical passive element layer and the at least one optical active element are stacked, and the x-direction and the y-direction are perpendicular to the z-direction and to each other.

A width of the tapered region in the x-direction may be 5 μm to 20 μm, a length of the tapered region in the y-direction may be 5 μm to 30 μm, and a height of the tapered region in the z-direction may be 1 μm to 3 μm.

An angle between a surface of the tapered region inclined in the z-direction and one surface of the substrate may be 5 degrees to 50 degrees.

The tapered region may include a semiconductor material and a first mask material.

The semiconductor material includes a Group III-V semiconductor material.

According to another aspect of an embodiment, a method of manufacturing an optical element array, may include: forming an optical passive element layer including at least one waveguide, on a substrate; forming a stack structure of a semiconductor material, a first mask material, and a second mask material, on the optical passive element layer; and forming at least one optical active element and an input and output region of the at least one optical active element by etching the stack structure, wherein the input and output region of the at least one optical active element may include a tapered region inclined in an x-direction, a y-direction, and a z-direction, and wherein the z-direction is a height direction of the substrate, along with the optical passive element layer and the at least one optical active element are stacked, and the x-direction and the y-direction are perpendicular to the z-direction and to each other.

A width of the tapered region in the x-direction may be 5 μm to 20 μm, a length of the tapered region in the y-direction may be 5 μm to 30 μm, and a height of the tapered region in the z-direction may be 1 μm to 3 μm.

An angle between a surface of the tapered region inclined in the z-direction and one surface of the substrate may be 5 degrees to 50 degrees.

The semiconductor material may include a Group III-V semiconductor material.

The first mask material may include at least one selected from SiN, silicon oxide, SiON, spin-on-glass (SOG), aluminum oxide, ArO, SiOF, benzocyclobutene (BCB), borophosphosilicate glass (BPSG), and any combination thereof.

The second mask material may include either one or both of photoresist and polyimide.

An etch rate of the first mask material may be greater than an etch rate of the semiconductor material, and an etch rate of the second mask material is greater than the etch rate of the first mask material.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram schematically illustrating an optical element array according to an embodiment;

FIG. 2 is a diagram schematically illustrating an optical passive element layer, an optical active element, and an optical input and output region, according to an embodiment;

FIG. 3 is a diagram schematically illustrating an optical input and output region according to an embodiment;

FIG. 4 is a cross-sectional view taken along line I-I′ of FIG. 3;

FIG. 5 is a cross-sectional view taken along a Y direction in FIG. 3;

FIG. 6 is a diagram schematically illustrating an optical input and output region according to another embodiment;

FIG. 7 is a cross-sectional view taken along a Y direction in FIG. 6;

FIG. 8 is a diagram schematically illustrating an optical input and output region according to another embodiment;

FIG. 9 is a cross-sectional view taken along line II-II′ of FIG. 8;

FIG. 10 is a cross-sectional view taken along a Y direction in FIG. 8;

FIGS. 11 to 13 are diagrams schematically illustrating a method of manufacturing an optical element array, according to an embodiment; and

FIG. 14 is a diagram illustrating an optical system according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Hereinafter, an optical element array, an optical system including the optical element array, and a method of manufacturing the optical element array, according to various embodiments, will be described in detail with reference to the accompanying drawings. In the following drawings, the same reference numerals denote the same elements, and the size of each element in the drawings may be exaggerated for clarity and convenience of explanation. While the terms such as “first” and “second” may be used to describe various elements, such elements should not be limited by these terms. These terms are only used to distinguish one element from another.

The singular forms as used herein are intended to include the plural forms as well unless the context clearly indicates otherwise. It will be understood that the terms “comprise,” “include,” or “have” as used herein specify the presence of stated elements, but do not preclude the presence or addition of one or more other elements. Also, sizes or heights of elements in the drawings may be exaggerated for clarity of explanation. Also, the expression “a certain material layer is present on a substrate or another layer” may mean that the material layer may be present in direct contact with the substrate or the other layer, and another third layer may intervene therebetween. Materials constituting layers in the following embodiments are only examples, and other materials may be used.

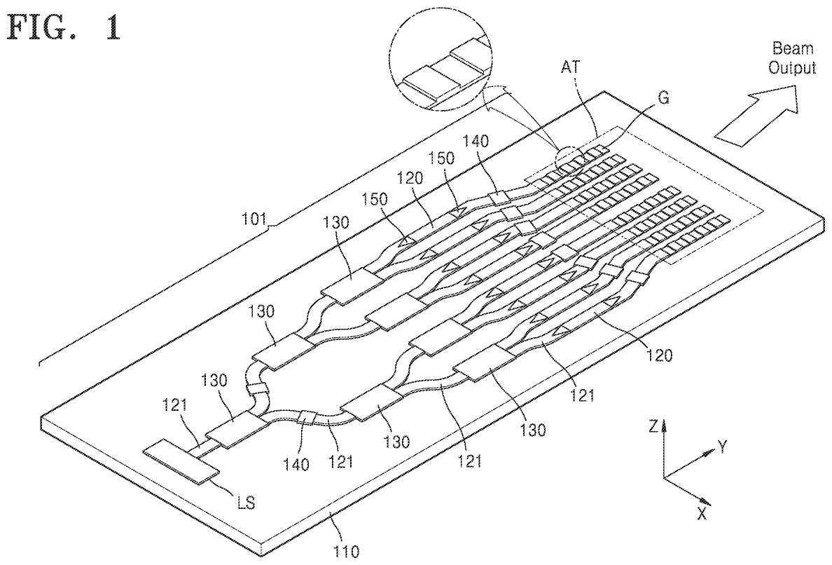

FIG. 1 is a diagram schematically illustrating an optical element array according to an embodiment.

Referring to FIG. 1, the optical element array may include at least one light source LS, a waveguide 121 that transmits a beam emitted from the at least one light source LS, a beam splitter 130 that splits the light beam transmitted through the waveguide 121, a phase shifter 120 that shifts a phase of the light beam, and an optical amplifier 140 that amplifies the light beam.

The waveguide 121 through which light propagates may be branched into a plurality of waveguides 121 by beam splitters 130. FIG. 1 illustrates a structure where one waveguide 121 is branched into eight waveguides 121 by seven beam splitters 130. Phase shifters 120 may be respectively provided in the waveguides 121 branched by the beam splitters 130. When electrical signals are applied to the phase shifters 120, the phase shifters 120 may independently change the phases of light beams passing through the waveguides 121.

An antenna AT may be further provided at an end portion of the waveguide 121 extending from the optical amplifier 140. The antenna AT may include a grating G formed in the waveguide 121. The traveling direction of the light beam may be adjusted according to the size, depth, pitch, and the like of the grating G. The phase shifter 120 may adjust the traveling direction of the light beam in order to scan the light beam in a horizontal direction with respect to the substrate 110, and the antenna AT may adjust the traveling direction of the light beam in order to scan the light beam in a height direction with respect to the substrate 110. The height direction with respect to the substrate 110 may include not only a vertical direction with respect to the substrate 110 but also an oblique direction with respect to the substrate 110.

On the other hand, light loss caused by light reflection may occur when light output from an optical active element such as the light source LS or the phase shifter 120 is received into an optical active element such as the waveguide 121 through an optical input and output region 150, or when light inside the waveguide 121 is input to the optical active element through the optical input and output region 150. Hereinafter, the optical input and output region 150 may refer to a mode converter since the light produced by the optical active element becomes linked with the passive element, through coupling at the mode converter. The mode converter may correspond to a point of convergence or contact between the active and passive elements. Because coupling occurs more easily as light reflection in the optical input and output region 150 decreases, an optical element array having the optical input and output region 150 with low light reflection is required.

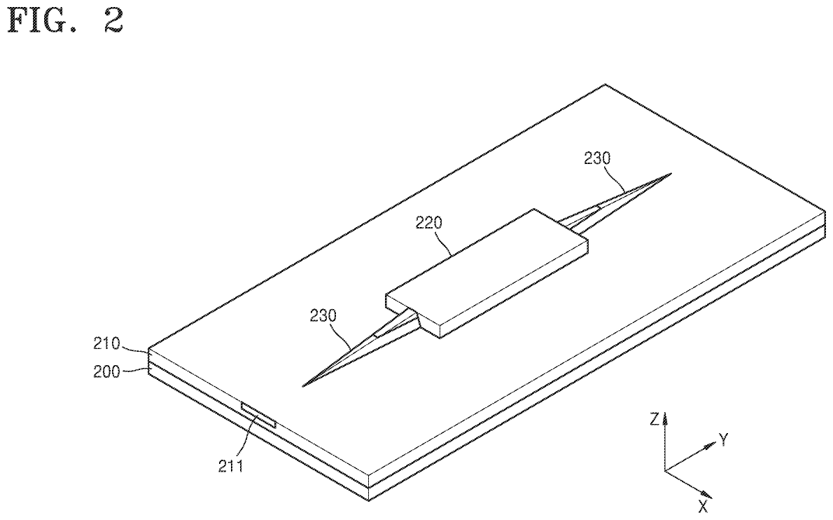

FIG. 2 is a diagram schematically illustrating an optical passive element layer 210, an optical active element 220, and an optical input and output region 230, according to an embodiment.

Referring to FIG. 2, the optical passive element layer 210 may be provided on a substrate 200, and a waveguide 211 may be provided in the optical passive element layer 210. The optical active element 220 may be provided on the optical passive element layer 210. The optical active element 220 may include the optical input and output region 230 on the waveguide 211. A light beam output from the optical active element 220 may be input to the waveguide 211 provided thereunder via the optical input and output region 230. Alternatively, the light beam inside the waveguide 211 may be input to the optical active element 220 via the optical input and output region 230 provided thereon.

In order to reduce light reflection, the optical input and output region 230 of the optical active element 220 may be inclined in a first direction (X direction), a second direction (Y direction), and a third direction (Z direction).

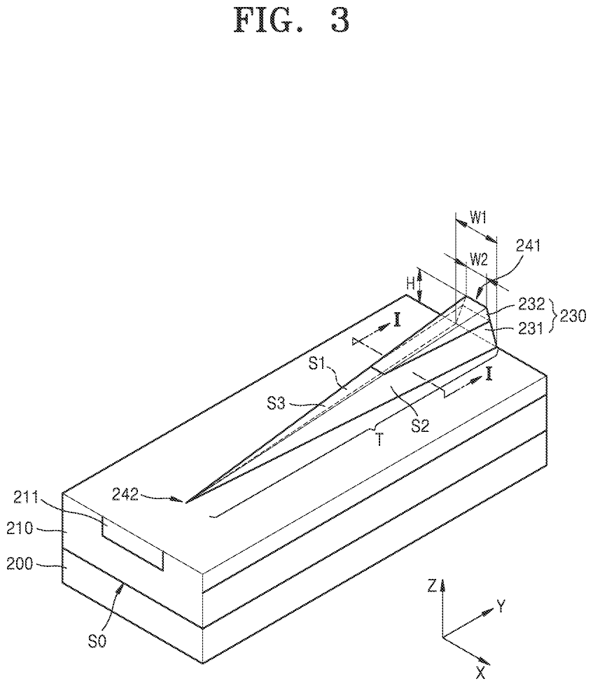

FIG. 3 is a diagram schematically illustrating the optical input and output region 230 according to an embodiment.

Referring to FIG. 3, the optical input and output region 230 may include a semiconductor material 231 and a first mask material 232. The semiconductor material 231 may be provided on the waveguide 211, and the first mask material 232 may be provided on the semiconductor material 231.

The optical input and output region 230 may include a tapered region T. The first direction (X direction) is a direction parallel to the substrate 200, the second direction (Y direction) is a direction parallel to the substrate 200 and perpendicular to the first direction (X direction), and the third direction (Z direction) is a direction perpendicular to the first direction (X direction) and the second direction (Y direction). The third direction (Z direction) may be a direction perpendicular to one surface S0 of the substrate 200 and may be a height direction of the substrate 200.

The optical input and output region 230 may have a height H on the waveguide 211 in the third direction (Z direction) and may include the tapered region T inclined in the first direction (X direction), the second direction (Y direction), and the third direction (Z direction). The tapered region T may have a structure in which widths W1 and W2 thereof gradually decrease in a direction (−Y direction) opposite to the second direction (Y direction). In addition, the tapered region T may have a structure in which a height H thereof gradually decreases in a direction (−Y direction) opposite to the second direction (Y direction). For example, widths W1 and W2 of a first end 241 of the tapered region T in the first direction (X direction) may be about 5 μm to about 20 μm and may gradually decrease to a second end 242 of the tapered region T. In addition, a length L of the tapered region T in the second direction (Y direction) may be about 15 μm to about 30 μm. In addition, a height H of the first end 241 of the tapered region T in the third direction (Z direction) may be about 1 μm to about 3 μm and may gradually decrease to the second end 242 of the tapered region T. The widths W1 and W2 and the height H of the tapered region T may decrease linearly from the first end 241 of the tapered region T to the second end 242 of the tapered region T. Alternatively, the widths W1 and W2 and the height H of the tapered region T may decrease non-linearly from the first end 241 of the tapered region T to the second end 242 of the tapered region T.

The tapered region T may include a first surface S1 and a second surface S2, which are side surfaces, and a third surface S3, which is a top surface. The first surface S1 and the second surface S2 may face each other in a shape inclined in the first direction (X direction) and the second direction (Y direction). The first surface S1 and the second surface S2 may be provided so that the height in the third direction (Z direction) gradually decreases from the first end 241 to the second end 242 in a direction (−Y direction) opposite to the second direction (Y direction). An angle between the first surface S1 and the one surface S0 of the substrate may be less than 90 degrees, and an angle between the second surface S2 and the one surface S0 of the substrate 200 may be less than 90 degrees. The third surface S3 may be in contact with the first surface S1 and the second surface S2, and the third surface S3 may be inclined in the third direction (Z direction). An angle between the third surface S3 and the one surface S0 of the substrate 200 may be less than 90 degrees.

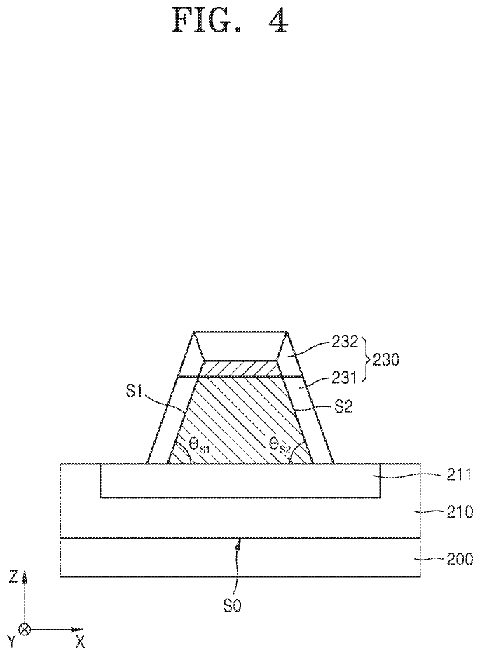

FIG. 4 is a cross-sectional view taken along line I-I′ of FIG. 3.

Referring to FIG. 4, an angle θ_{S1} between the first surface S1 of the optical input and output region 230 and the one surface S0 of the substrate 200 may be less than 90 degrees, and an angle θ_{S2} between the second surface S2 of the optical input and output region 230 and the one surface S0 of the substrate 200 may be less than 90 degrees.

Although FIG. 4 illustrates that the angle between the first surface S1 of the optical input and output region 230 and the one surface S0 of the substrate 200 and the angle between the second surface S2 of the optical input and output region 230 and the one surface S0 of the substrate 200 are uniform, the angle between the first surface S1 of the optical input and output region 230 and the one surface S0 of the substrate 200 and the angle between the second surface S2 of the optical input and output region 230 and the one surface S0 of the substrate 200 may not be uniform. For example, the angle between the first surface S1 of the optical input and output region 230 and the one surface S0 of the substrate 200 and the angle between the second surface S2 of the optical input and output region 230 and the one surface S0 of the substrate 200 are a first angle at the end 241 of FIG. 3 and a second angle less than the first angle at the second end 242 of FIG. 3 and may gradually decrease in the second direction (Y direction). Alternatively, the angle between the first surface S1 of the optical input and output region 230 and the one surface S0 of the substrate 200 and the angle between the second surface S2 of the optical input and output region 230 and the one surface S0 of the substrate 200 are a first angle at the end 241 of FIG. 3 and a second angle greater than the first angle at the second end 242 of FIG. 3 and may gradually decrease in the second direction (Y direction).

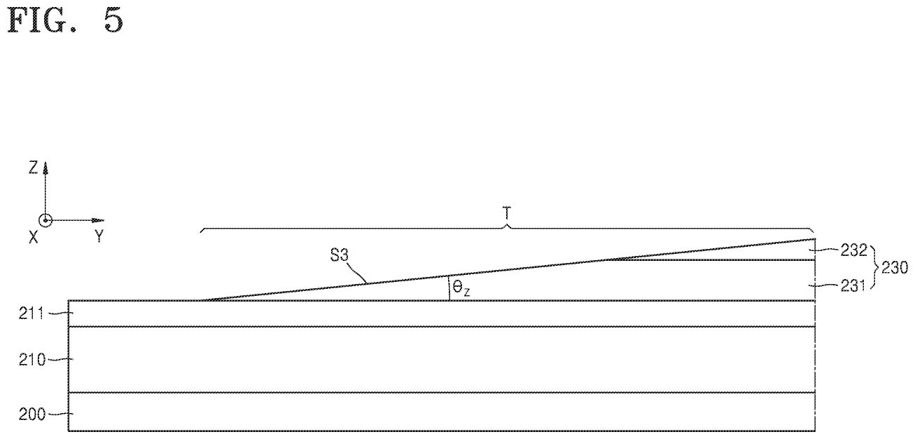

FIG. 5 is a cross-sectional view taken along the Y direction in FIG. 3.

Referring to FIG. 5, an angle θ_{z} between the third surface S3 of the tapered region T of the optical input and output region 230 and the one surface S0 of the substrate 200 may be less than 90 degrees. For example, the angle θ_{z} between the third surface S3 of the tapered region T of the optical input and output region 230 and the one surface S0 of the substrate 200 may be about 5 degrees to about 50 degrees.

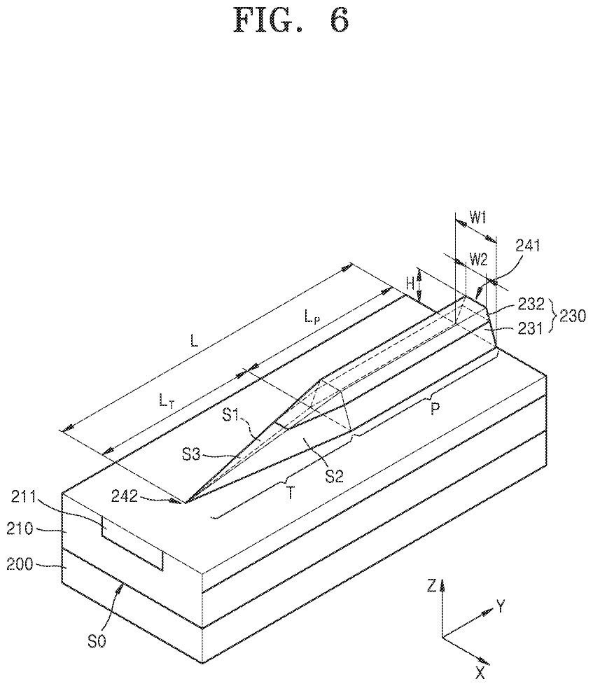

FIG. 6 is a diagram schematically illustrating an optical input and output region according to another embodiment. In FIG. 6, differences from FIG. 3 are mainly described.

Referring to FIG. 6, the optical input and output region 230 may include a parallel region P and a tapered region T. Widths W1 and W2 of the parallel region P in the first direction (X direction) and a height H of the parallel region P in the third direction (Z direction) are substantially uniform in the second direction (Y direction). The widths W1 and W2 of the parallel region P may be about 5 μm to about 20 μm, and the height H of the parallel region P may be about 1 μm to about 3 μm. A total length L of the parallel region P and the tapered region T in the second direction (Y direction) may be about 5 μm to about 30 μm. The widths W1 and W2 and the height H of the tapered region T may gradually decrease to the second end 242 of the tapered region T. In addition, the cross-sectional view of the optical input and output region 230 in the X direction of FIG. 6 may be similar to that of FIG. 4.

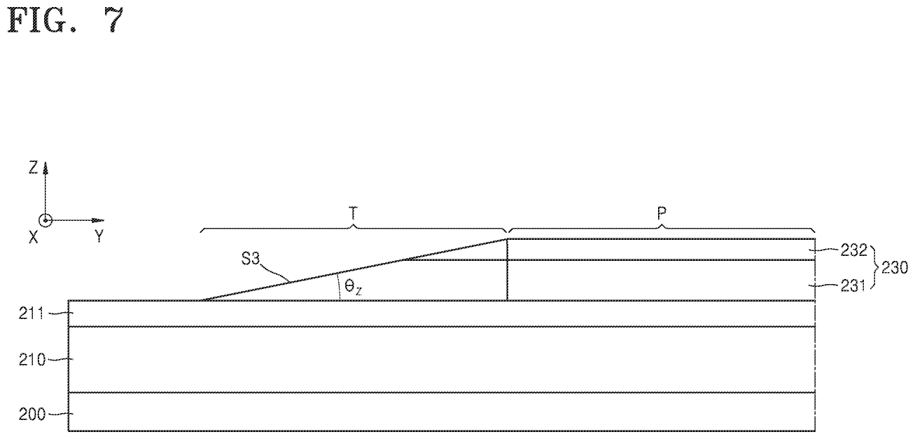

FIG. 7 is a cross-sectional view taken along the Y direction in FIG. 6. In FIG. 7, differences from FIG. 5 are mainly described.

Referring to FIG. 7, the angle θ_{z} between the third surface S3 of the tapered region T of the optical input and output region 230 and the one surface S0 of the substrate 200 may be less than 90 degrees, and the third surface S3 of the parallel region P of the optical input and output region 230 may be substantially parallel to the one surface S0 of the substrate 200.

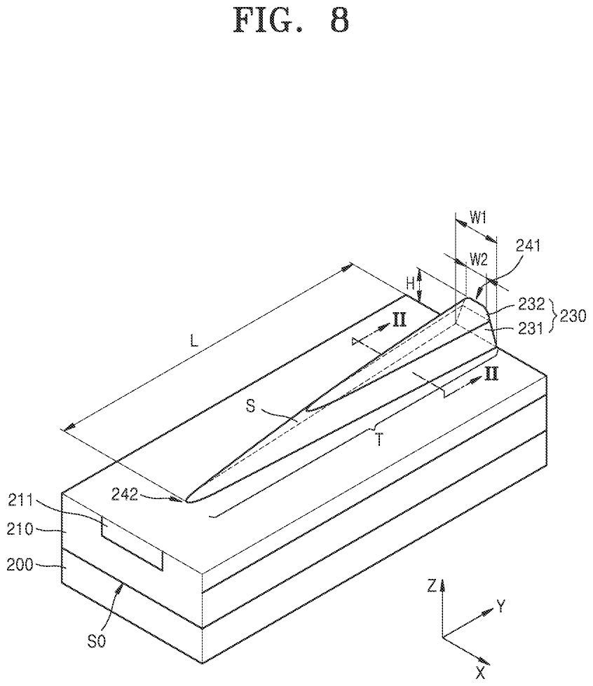

FIG. 8 is a diagram schematically illustrating an optical input and output region according to another embodiment. In FIG. 8, differences from FIG. 3 are mainly described.

Although FIG. 3 illustrates that the first surface S1, the second surface S2, and the third surface S3 are all flat, the tapered region T may have a curved surface S, as illustrated in FIG. 8.

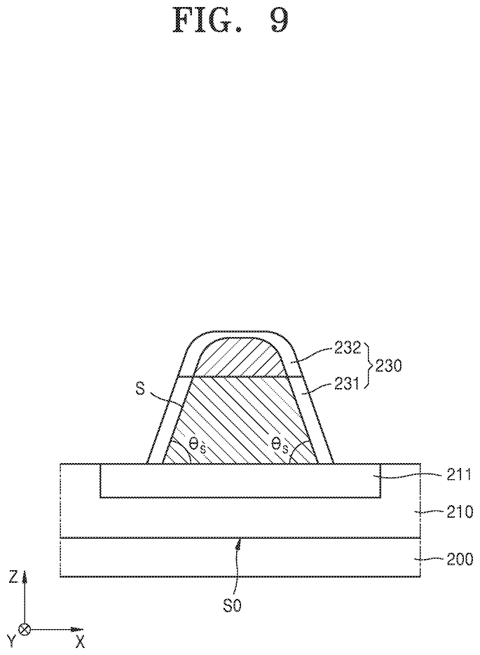

FIG. 9 is a cross-sectional view taken along line II-II′ of FIG. 8.

Referring to FIG. 9, an angle θ_{S} between each of two ends of the curved surface S of the optical input and output region 230 inclined in the first direction (X direction) and the second direction (Y direction) and the one surface S0 of the substrate 200 may be less than 90 degrees.

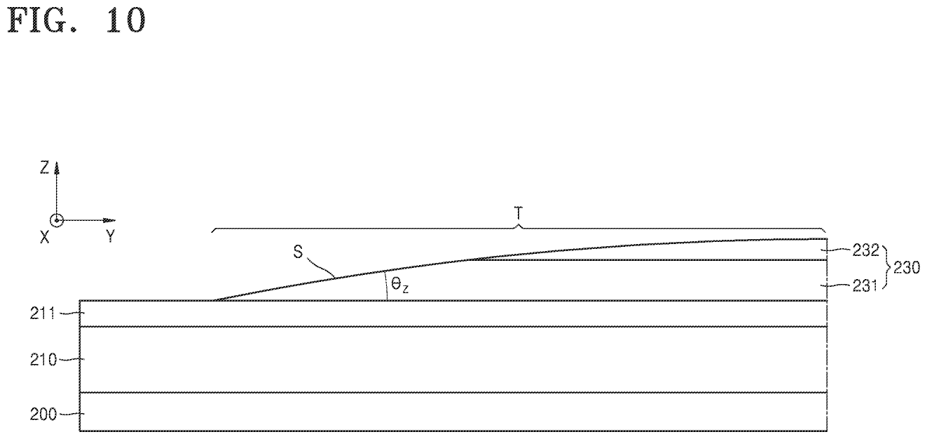

FIG. 10 is a cross-sectional view taken along the Y direction in FIG. 8.

Referring to FIG. 10, an angle θ_{z} between the central region of the curved surface S of the tapered region of the optical input and output region 230 inclined in the third direction (Z direction) and the one surface S0 of the substrate 200 may be less than 90 degrees. For example, the angle θ_{z} between the central region of the curved surface S of the tapered region of the optical input and output region 230 inclined in the third direction (Z direction) and the one surface S0 of the substrate 200 may be about 5 degrees to about 50 degrees.

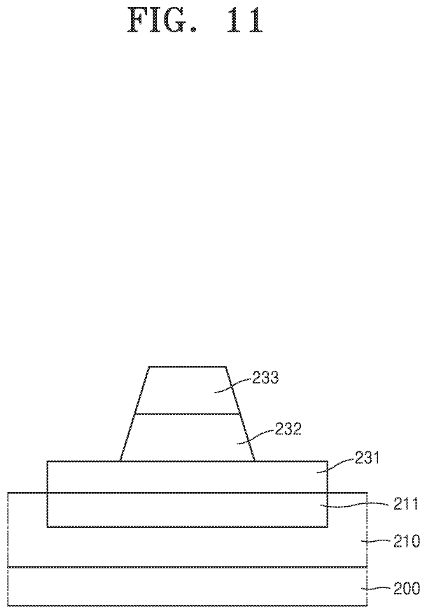

FIGS. 11 to 13 are diagrams schematically illustrating a method of manufacturing an optical element array, according to an embodiment.

Referring to FIG. 11, an optical passive element and an optical passive element layer 210 including a waveguide 211 may be formed on a substrate 200. A semiconductor material 231, a first mask material 232, and a second mask material 233 may be sequentially stacked on the optical passive element layer 210 including the waveguide 211. Etch rates of the semiconductor material 231, the first mask material 232, and the second mask material 233 may be in the order of the second mask material 233 >the first mask material 232>the semiconductor material 231. The semiconductor material 231 may include a Group III-V semiconductor material. The first mask material 232 may include at least one selected from photoresist, polyimide, and any combination thereof. The second mask material 233 may include at least one selected from SiN, silicon oxide (SiOₓ), SiON, spin-on-glass (SOG), aluminum oxide (AlOₓ), ArO, SiOF, benzocyclobutene (BCB), borophosphosilicate glass (BPSG), and any combination thereof.

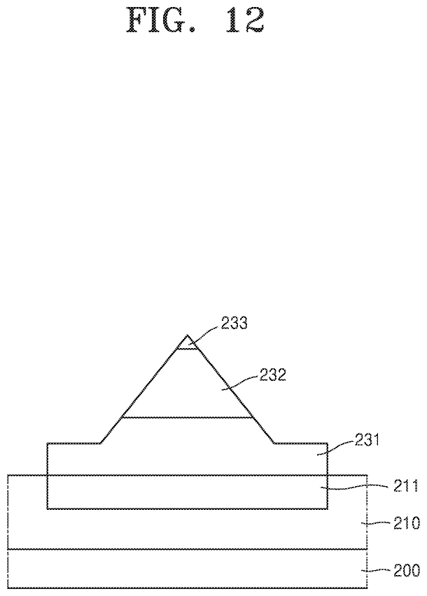

Referring to FIG. 12, the first mask material 232 and the second mask material 233 may be etched together while the semiconductor material 231 is being etched. As etching proceeds, the angle between each of the first surface S1 and the second surface S2 of the optical input and output region 230 including the first mask material 232 and the semiconductor material 231 and the one surface S0 of the substrate 200 may also gradually decrease.

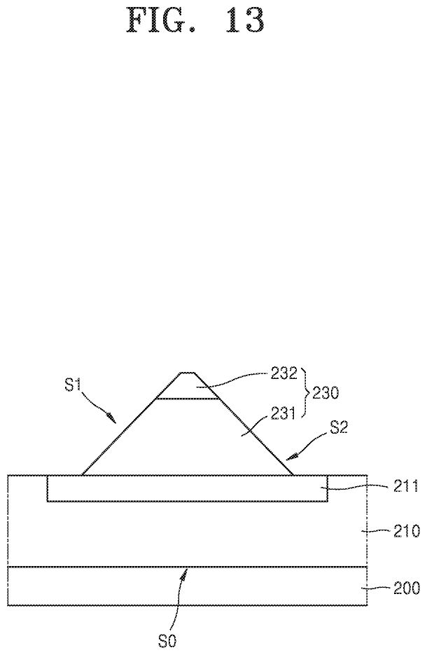

Referring to FIG. 13, after the semiconductor material 231 is etched, the second mask material 233 may disappear and the first mask material 232 may also be partially etched.

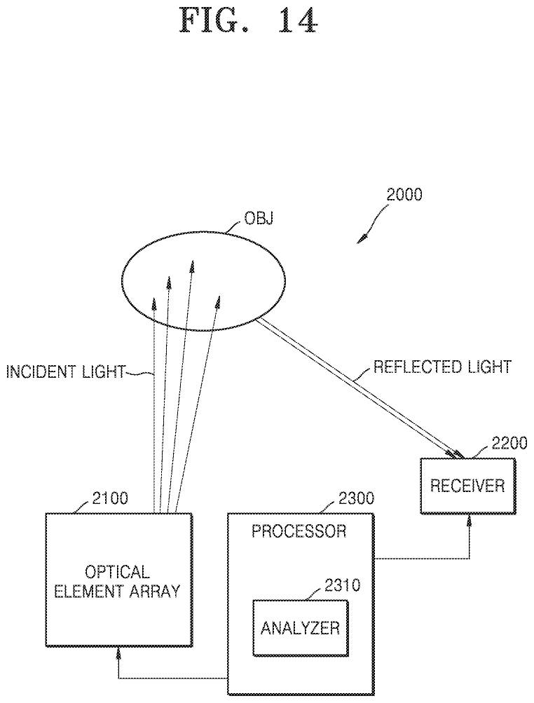

FIG. 14 is a block diagram schematically illustrating a configuration of an optical system 2000 according to an embodiment.

Referring to FIG. 14, the optical system 2000 may include an optical element array 2100 that generates light and adjusts the traveling direction of the light toward an object OBJ, a receiver 2200 that receives light reflected from the object OBJ, and a processor 2300 that controls the optical element array 2100.

The optical element array 2100 may include a light source LS and an optical phased array element 101 illustrated in FIG. 1.

The processor 2300 may control overall operations of the optical system 2000. The processor 2300 may include an analyzer 2310 that analyzes the distribution by location and/or by time of the light received by the receiver 2200 and classifies and processes light incident on the object OBJ in multiple directions.

The receiver 2200 is configured to capture and process the light signals that bounce back from the object OBJ, to measure a time delay between the transmitted and received signals, and calculate the distance to the object OBJ. The receiver 2200 may include at least one of an antenna array, a photodetector configured to detect incoming light signals and convert them into electrical signals, optical components (e.g., lenses, mirrors, and/or optical fibers) configured to focus and direct the incoming light signals onto the photodetector, amplification circuitry (e.g., an transimpedance amplifier) configured to amplify the electrical signals generated by the photodetector before further processing when the electrical signals generated by the photodetector are weak, and a time-to-digital converter configured to measure the time delay between the transmitted and received signals, and convert the time interval between the transmitted and received signals into a digital value that can be processed by the processor 2300.

As described above, the optical system 2000 including the optical element array 2100, according to various embodiments, may be a light detection and ranging (LiDAR). The LiDAR may detect a distance to an object, direction, speed, temperature, material distribution, and concentration characteristics by irradiating a laser to a target. The LiDAR may be used in laser scanners and three-dimensional (3D) imaging cameras for autonomous vehicles. The LiDAR may be applied to LiDAR for vehicles, LiDAR for robots, LiDAR for drones, and the like.

In addition, the optical element array 2100 according to various embodiments may be applied to intruder detection systems for security, hybrid laser diodes, semiconductor optical amplifiers, subway screen door obstacle detection systems, 3D sensors, depth sensors, user face recognition sensors in mobile phones, augmented reality (AR), motion recognition and object profiling on televisions (TVs) or entertainment devices, and the like.

The optical element array and the method of manufacturing the same, according to various embodiments, may provide a laser diode with low light reflection, an optical element array including the laser diode, and a system including the optical element array.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An optical element array comprising:
a substrate;
an optical passive element layer provided on the substrate and comprising at least one waveguide; and
at least one optical active element provided on the optical passive element layer,
wherein an input and output region of the at least one optical active element comprises a tapered region inclined in an x-direction, a y-direction, and a z-direction, and
wherein the z-direction is a height direction of the substrate, along with the optical passive element layer and the at least one optical active element are stacked, and the x-direction and the y-direction are perpendicular to the z-direction and to each other.

2. The optical element array of claim 1, wherein a width of the tapered region in the x-direction is 5 μm to 20 μm, a length of the tapered region in the y-direction is 5 μm to 30 μm, and a height of the tapered region in the z-direction is 1 μm to 3 μm.

3. The optical element array of claim 1, wherein an angle between a surface of the tapered region inclined in the z-direction and one surface of the substrate is 5 degrees to 50 degrees.

4. The optical element array of claim 1, wherein the tapered region includes a semiconductor material and a first mask material.

5. The optical element array of claim 4, wherein the semiconductor material includes a Group III-V semiconductor material.

6. The optical element array of claim 4, wherein the first mask material includes any one or any combination of SiN, silicon oxide, SiON, spin-on-glass (SOG), aluminum oxide, ArO, SiOF, and benzocyclobutene (BCB), borophosphosilicate glass (BPSG), and any combination thereof.

7. An optical system comprising:
an optical element array configured to generate light and adjust a traveling direction of the light toward an object;
a receiver configured to receive light from the object; and
a processor configured to control the receiver and the optical element array,
wherein the optical element array comprises:
a substrate;
an optical passive element layer on the substrate and comprising at least one waveguide; and
at least one optical active element on the optical passive element layer, wherein an input and output region of the at least one optical active element comprises a tapered region inclined in an x-direction, a y-direction, and a z-direction, and
wherein the z-direction is a height direction of the substrate, along with the optical passive element layer and the at least one optical active element are stacked, and the x-direction and the y-direction are perpendicular to the z-direction and to each other.

8. The optical system of claim 7, wherein a width of the tapered region in the x-direction is 5 μm to 20 μm, a length of the tapered region in the y-direction is 5 μm to 30 μm, and a height of the tapered region in the z-direction is 1 μm to 3 μm.

9. The optical system of claim 7, wherein an angle between a surface of the tapered region inclined in the z-direction and one surface of the substrate is 5 degrees to 50 degrees.

10. The optical system of claim 7, wherein the tapered region includes a semiconductor material and a first mask material.

11. The optical system of claim 10, wherein the semiconductor material includes a Group III-V semiconductor material.

12. A method of manufacturing an optical element array, the method comprising:
forming an optical passive element layer comprising at least one waveguide, on a substrate;
forming a stack structure of a semiconductor material, a first mask material, and a second mask material, on the optical passive element layer; and
forming at least one optical active element and an input and output region of the at least one optical active element by etching the stack structure,
wherein the input and output region of the at least one optical active element comprises a tapered region inclined in an x-direction, a y-direction, and a z-direction, and
wherein the z-direction is a height direction of the substrate, along with the optical passive element layer and the at least one optical active element are stacked, and the x-direction and the y-direction are perpendicular to the z-direction and to each other.

13. The method of claim 12, wherein a width of the tapered region in the x-direction is 5 μm to 20 μm, a length of the tapered region in the y-direction is 5 μm to 30 μm, and a height of the tapered region in the z-direction is 1 μm to 3 μm.

14. The method of claim 12, wherein an angle between a surface of the tapered region inclined in the z-direction and one surface of the substrate is 5 degrees to 50 degrees.

15. The method of claim 12, wherein the semiconductor material includes a Group III-V semiconductor material.

16. The method of claim 12, wherein the first mask material includes at least one selected from SiN, silicon oxide, SiON, spin-on-glass (SOG), aluminum oxide, ArO, SiOF, benzocyclobutene (BCB), borophosphosilicate glass (BPSG), and any combination thereof.

17. The method of claim 12, wherein the second mask material includes either one or both of photoresist and polyimide.

18. The method of claim 12, wherein an etch rate of the first mask material is greater than an etch rate of the semiconductor material, and an etch rate of the second mask material is greater than the etch rate of the first mask material.
